(19) United States
(12) Patent Application Publication
(10) Pub. No.: US 2017/0021713 A1
(43) Pub. Date: Jan. 26, 2017

(54) TRANSMISSION ASSEMBLY FOR A HYBRID VEHICLE EQUIPPED WITH A PENDULUM DAMPER

(71) Applicant: VALEO EMBRAYAGES, Amiens Cedex 2 (FR)

(72) Inventors: Gilles LEBAS, Villiers Bretonneux (FR); Fabien LEBEAU, Harly (FR)

(21) Appl. No.: 15/104,826

(22) PCT Filed: Dec. 9, 2014
(86) PCT No.: PCT/FR2014/053237

§ 371 Date: Jun. 15, 2016

(30) Foreign Application Priority Data
Dec. 20, 2013 (FR) 1363321

(51) Int. Cl. B60K 6/365; F16F 15/14; B60K 6/50; B60K 6/26; B60K 6/48; F16H 1/28; F16F 15/123

(52) U.S. Cl. CPC B60K 6/365; F16H 1/28; F16F 15/1478; F16F 15/12353; B60K 6/26; B60K 6/48; B60K 6/50; F16H 2001/2881; B60Y 2200/92; B60Y 2400/48; B60Y 2400/73; Y10S 903/91

(57) ABSTRACT

A transmission assembly for a motor vehicle is to be arranged between a combustion engine having a crankshaft and a gearbox having an input shaft. The assembly comprises an electric machine having an external stator and an internal rotor rotationally movable. The rotor has a central opening. An intermediate shaft passes through the central opening to be connected kinematically to the crankshaft and to the input shaft of the gearbox. A mechanical reducer is configured to rotationally couple the rotor and the intermediate shaft so that the rotation speed of the rotor is higher than the rotation speed of the intermediate shaft. A pendulum damper has a rotationally movable support member, and pendulum flyweights are mounted movably on the support member. The support member is rotationally integral with the rotor.

### TECHNICAL FIELD OF THE INVENTION

The invention relates to the field of transmissions for motor vehicles. It relates in particular to a transmission assembly intended to be arranged between a combustion engine and a gearbox of a motor vehicle.

It relates in particular to a transmission assembly for a motor vehicle of the hybrid type in which an electric machine is arranged in the transmission system between the engine and the gearbox.

### BACKGROUND OF THE INVENTION

Transmission assemblies arranged between the gearbox and the combustion engine, having an electric machine and a clutch on the engine side allowing the crankshaft of the combustion engine to be rotationally coupled to the rotor of the electric machine, are known in the existing art. It is thus possible to shut off the internal combustion engine at each stop, and to restart it thanks to the electric machine. The electric machine can also constitute an electrical brake or can supply surplus energy to the combustion engine in order to assist it or prevent it from stalling. The electric machine can also provide drive for the vehicle. When the engine is running the electric machine plays the part of an alternator.

In order to filter vibrations brought about by irregularities of the combustion engine, it is known to integrate pendulum dampers, also called “pendulum oscillators” or “pendulums,” into the transmission assemblies recited above. In the absence of such dampers, vibrations penetrating into the gearbox would produce particularly undesirable impacts, noise, or acoustic annoyances therein during operation. Transmission assemblies of this kind equipped with a pendulum damper are disclosed in particular in the documents US 2011/0162480 and WO 12136179.

The performance of a pendulum damper in terms of filtering irregularities increases in particular with the mass of the pendulum flyweights that are used. Pendulum dampers of the existing art are consequently of significant size in order to achieve satisfactory performance. A hybrid transmission assembly as described above is, however, subject to severe size constraints so that it can be installed between the engine and gearbox of the vehicle.

The pendulum dampers integrated into hybrid transmission assemblies such as those described in the existing art thus do not allow satisfactory filtering performance to be achieved given the size constraints that must be complied with. This is even more problematic given that the development of new, fuel-efficient engine solutions results in an increase in their irregularities.

### OBJECT OF THE INVENTION

An idea on which the invention is based is that of proposing a transmission assembly for a hybrid vehicle which is equipped with means allowing effective absorption of vibrations.

According to an embodiment the invention provides a transmission assembly for a motor vehicle, intended to be arranged between a combustion engine having a crankshaft and a gearbox having an input shaft, said assembly comprising:
a support element;
an electric machine having a stator carried by the support element and a rotor rotationally movable around an axis X, said rotor having a central opening;
an intermediate shaft passing through the central opening of the rotor and intended on the one hand to be connected kinematically to the crankshaft of the combustion engine and on the other hand to be connected kinematically to the input shaft of the gearbox;
a mechanical reducer configured to rotationally couple the rotor and the intermediate shaft in such a way that the rotation speed of the rotor is higher than the rotation speed of the intermediate shaft; and
a pendulum damper having a support member rotationally movable around the axis X, and pendulum flyweights mounted movably on the support member, the support member being rotationally integral with the rotor.

The mechanical reducer is thus disposed between the pendulum damper and the intermediate shaft in such a way that the effects of the pendulum damper on the rotational irregularities of the intermediate shaft become amplified. Such a configuration thus allows the pendulum damper to achieve satisfactory filtering performance while complying with size requirements.

The mechanical reducer furthermore allows the performance of the electric machine to be enhanced by limiting its operation at low speed, at which its efficiency is lower.

According to other advantageous embodiments such an assembly can exhibit one or more of the following characteristics:
The intermediate shaft is intended to be connected kinematically to the crankshaft by means of a clutch.
The mechanical reducer is an epicyclic gear train.
The epicyclic gear train extends radially inside the rotor. The impact of the mechanical reducer on the overall size of the transmission assembly is thus negligible.
The epicyclic gear train has a first ring gear carried by a support hub of the rotor, a second ring gear fastened to the intermediate shaft, and satellite gears mounted rotationally movably on the support element and extending inside said first and second ring gears, said satellite gears each being provided with a first tooth set meshing with the first ring gear and a second tooth set meshing with the second ring gear. An epicyclic gear train of this kind offers limited dimensions and satisfactory force balance.
The support element has an inner portion extending inside the central opening of the rotor, the intermediate shaft being centered and rotationally guided on said inner portion of the support element by means of a first bearing, and the support hub of the rotor being centered and rotationally guided on said inner portion of the support element by means of a second bearing.
The rotor is carried by a support hub, and the support member of the pendulum damper is fastened on the support hub of the rotor.
The stator has coils distributed circumferentially around the axis X and an annularly shaped interconnector to interconnect the coils, said interconnector being offset axially with respect to the coils, the pendulum damper being at least partly received radially inside the interconnector.
The transmission assembly has an elastic-member torsional damper configured to transmit a torque and to damp rotational irregularities between the intermediate shaft and the input shaft of the gearbox, and the pendulum damper is at least partly arranged in the plane of the elastic-member torsional damper and extends radially above the elastic-member torsional damper.
The pendulum damper is integrated into the body of the rotor.
The rotor has a body constituted by an axially stacked metal-sheet package, and some of the metal sheets of the metal-sheet package have cutouts defining receiving spaces for the pendulum flyweights.
The pendulum flyweights are mounted movably on the support member by means of guidance rollers engaged into orifices of the flyweights, and the support member for the flyweights has annular flanges that are arranged axially on either side of the receiving spaces for the flyweights and are equipped with orifices into which the ends of the guidance rollers are engaged.
The annular flanges are constituted by metal sheets of the metal-sheet package.
The support member and/or the pendulum flyweights are produced from a nonmagnetic material.

According to an embodiment the invention provides a motor vehicle equipped with a transmission assembly recited above.

The invention will be better understood, and other objectives, details, characteristics, and advantages thereof will emerge more clearly, in the course of the description below of several particular embodiments of the invention, provided solely for illustrative and not limiting purposes and referring to the attached Figures.

In these Figures:

FIG. 1 is a partial section view of a transmission assembly intended to be arranged between a combustion engine and a gearbox, according to a first embodiment of the invention.

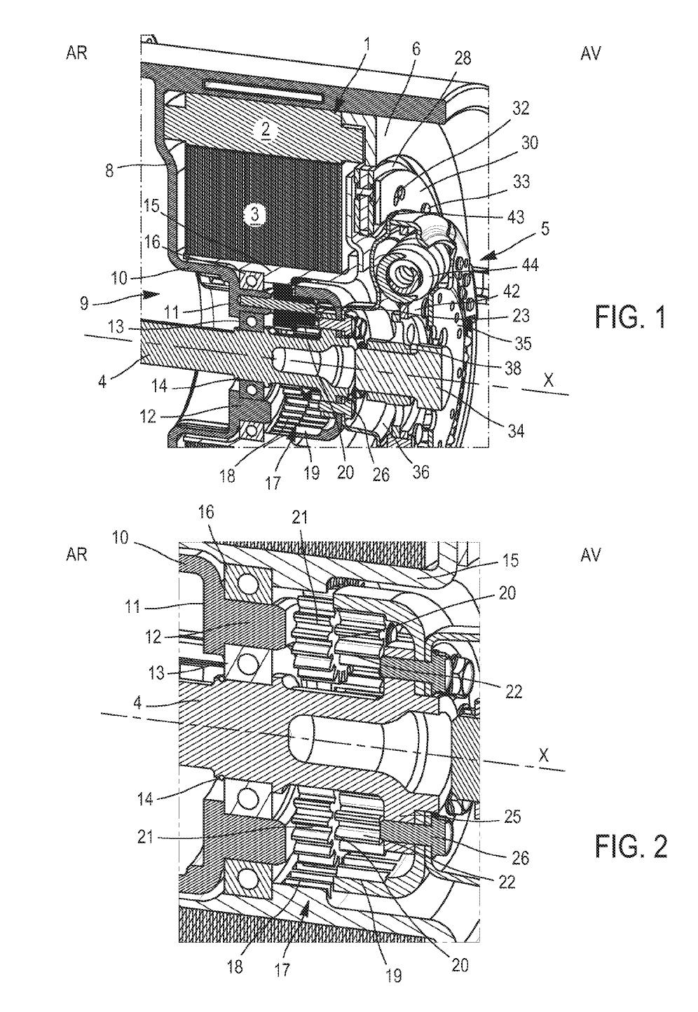

FIG. 2 is a detail view of the mechanical reducer configured to couple the rotor of the electric machine and the intermediate shaft.

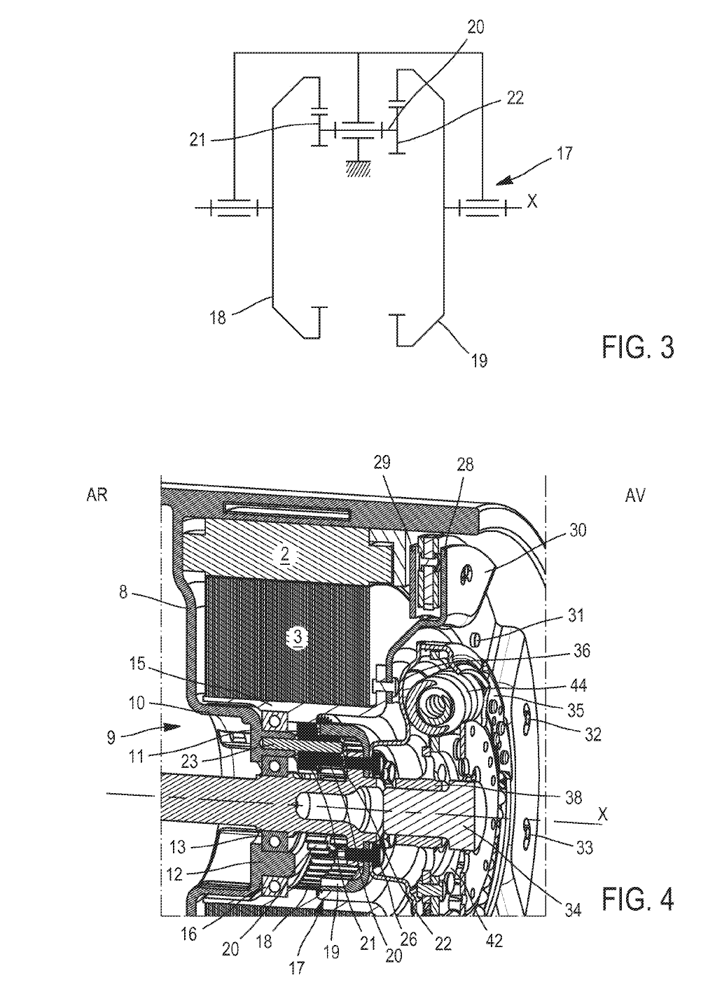

FIG. 3 is a schematic depiction of the mechanical reducer of FIG. 2.

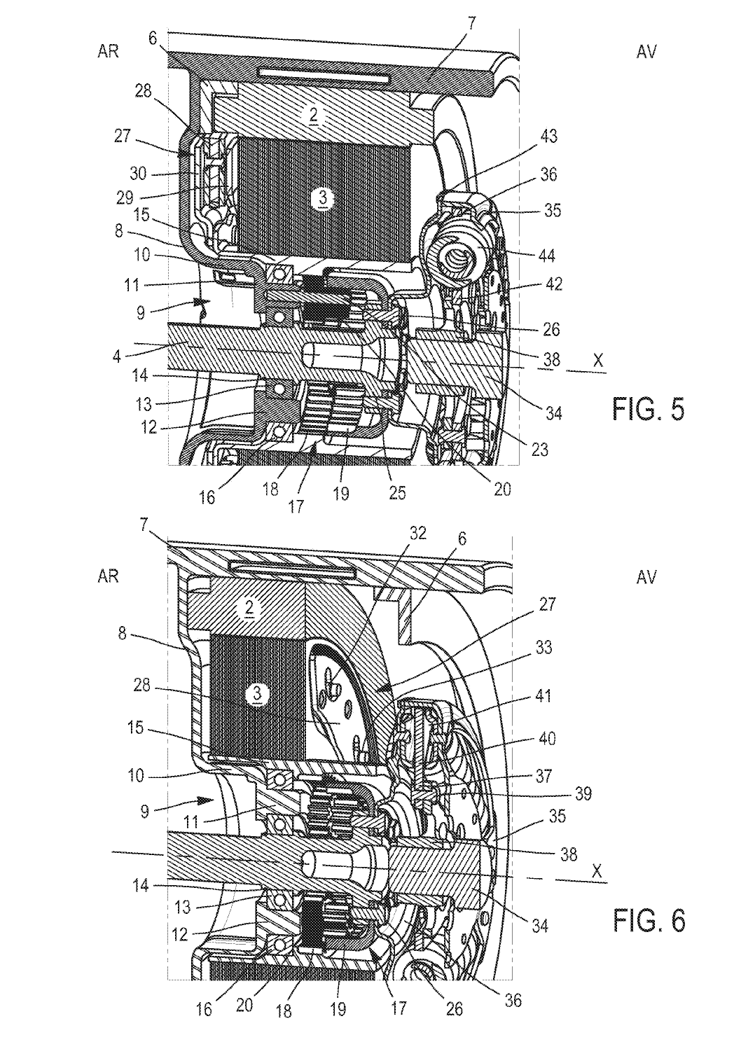

FIGS. 4 and 5 are partial views, in section, of a transmission assembly respectively according to a second and a third embodiment.

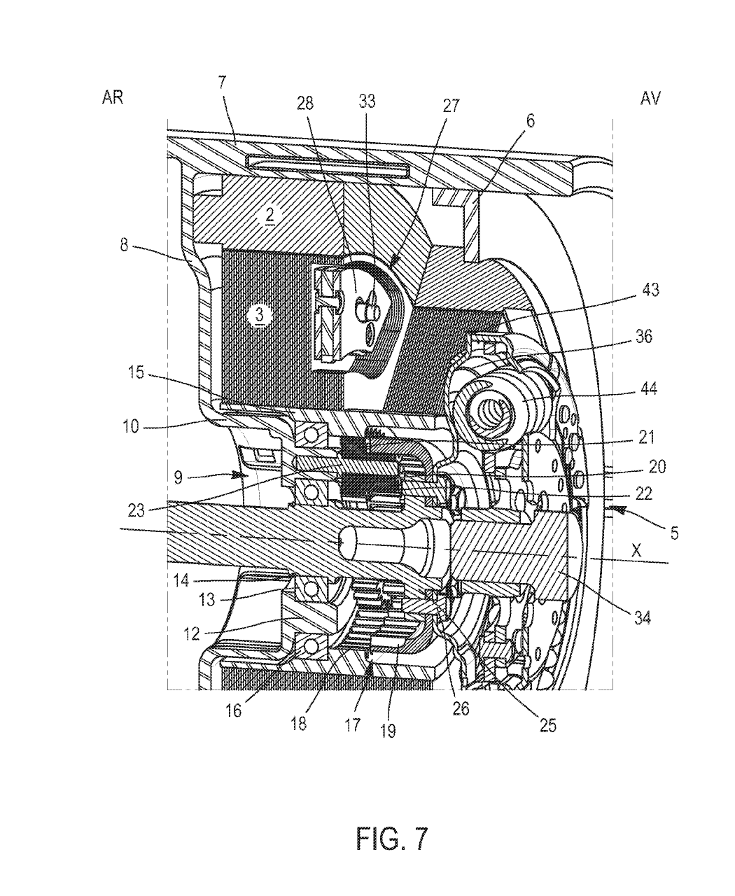

FIGS. 6 and 7 are partial views, in section, of a transmission assembly respectively according to a fourth and a fifth embodiment.

### DETAILED DESCRIPTION OF EMBODIMENTS

In the description and the claims the terms “outer” and “inner,” as well as the orientations “axial” and “radial,” will be used to designate elements of the transmission assembly in accordance with the definitions given in the description. By convention, the “radial” orientation is directed orthogonally to the rotation axis X of the transmission assembly which determines the “axial” orientation; and, moving from inside to outside away from said axis X, the “circumferential” orientation is directed orthogonally to the rotation axis X of the transmission assembly and orthogonally to the radial direction. The terms “outer” and “inner” are used to define the relative position of one element with respect to another with reference to the axis X; an element close to the axis is thus referred to as “inner” as opposed to an “outer” element located radially at the periphery. The terms “rear” (AR) and “front” (AV) are furthermore used to define the relative position of one element with respect to another along the axial direction, an element intended to be placed close to the combustion engine being designated “rear” and an element intended to be placed close to the gearbox being designated “front.”

Referring to FIG. 1, this shows a transmission assembly intended to be arranged between a combustion engine and a gearbox. The transmission assembly has an electric machine 1 comprising an external stator 2 and an internal rotor 3, provided with a central opening and an intermediate shaft 4 passing through the central opening of rotor 3.

Intermediate shaft 4 has a rear end interacting with a clutch (not depicted) allowing the crankshaft of the combustion engine to be rotationally coupled to intermediate shaft 4. To achieve this, the rear end of intermediate shaft 4 is equipped with splines (not depicted) intended to interact with a splined means of a clutch disk. The clutch has a clutch cover fastened on the outer periphery of the engine flywheel, a movable pressure plate, an annular diaphragm axially loading the pressure plate, and a release bearing capable of causing the diaphragm to pivot so as to displace the pressure plate. The pressure plate is thus capable of being displaced toward an engaged position in which it clamps the friction linings of the clutch disk against a reaction plate carried by the engine flywheel. In an engaged position, driving torque is then transmitted from the crankshaft of the combustion engine to intermediate shaft 4. According to an embodiment, the engine flywheel is a dual mass flywheel.

Intermediate shaft 4 is furthermore intended to be rotationally coupled to an input shaft 34 of the gearbox by means of a torsional damper 5. The assembly is thus capable of transmitting a torque between the crankshaft of the combustion engine and the input shaft of the gearbox.

Electric machine 1 is a reversible rotating electric machine of the alternator/starter type. In starter mode the clutch is engaged and the electric machine allows starting of the combustion engine. In alternator mode the electric machine allows a battery of the vehicle to be recharged and/or allows energy-consuming elements or accessories to be powered while the combustion engine is running. It is furthermore configured to recover energy upon braking of the vehicle. Electric machine 1 can be configured in particular to shut off the combustion engine, for example at red lights or in traffic jams, and then to start it (“stop and go” function). In an embodiment it is capable of supplying additional power (“boost” function). The electric machine is furthermore capable of driving the vehicle at least over a short distance, the clutch then being disengaged and the combustion engine shut off.

Electric machine 1 is a polyphase electric machine. The stator of the electric machine has a winding equipped with a plurality of coils distributed circumferentially around the axis X. The coils are interconnected to one another with the aid of an interconnector 6. In FIGS. 1, 2, 4, 6, and 7 the interconnector is offset axially toward the gearbox with respect to the coils. In the embodiment of FIG. 5, conversely, interconnector 6 is offset axially toward the combustion engine with respect to the coils.

In an embodiment, interconnector 6 has four annularly shaped frames extending in a radial plane. The frames are electrically conductive, being made e.g. of copper or advantageously of another weldable metallic material. These frames are stacked axially on one another and electrically insulated from one another. Preferably the frames are embedded in a body made of electrically insulating material, such as a plastic material. Each frame carries on its inner periphery tabs extending radially protrudingly toward the inside of the frame, which are welded to the ends of the stator coils. Each coil has a first end called an “input” intended to be connected to one of the phase frames, and a second end called an “output” intended to be connected to the neutral frame. The “inputs” of the coils are alternately connected to the phase frames. Each phase frame has on its outer periphery a connecting terminal for interconnection with a power connector.

Rotor 3 is a permanent-magnet rotor. It has a body constituted by a package of metal sheets stacked in the axial direction and by permanent magnets (not depicted) installed radially in the metal sheets of the metal-sheet package at the outer periphery of rotor 3.

Stator 2 is carried by a support element 7 that on the one hand is intended to be fastened to the engine block and on the other hand is intended to be fastened to the gearbox housing. Support element 7 is inserted between the gearbox housing and the engine block, and is configured to allow fastening of the gearbox to the engine block. In other words, support element 7 constitutes, in a way, a spacer between the engine block and the gearbox housing.

Support element 7 has an outer peripheral wall whose inner surface is cylindrical in shape in order to interact with the outer periphery of stator 2. Mounting of stator 2 in support element 7 can be achieved by shrink-fitting or by force-fitting. Support element 7 also has an inner web 8 extending to the rear of stator 2 and of rotor 3, and constituting a separating wall between the clutch on the one hand and electric machine 1 on the other hand. Support element 7 also defines a receptacle 9 which extends inside rotor 3 and inside which a release bearing (not depicted) is intended to be at least partly received. A configuration of this kind allows the axial dimension of the assembly to be optimized. The receptacle is defined by an axial skirt 10 and a radially oriented bottom 11. Bottom 11 is equipped with a bore allowing intermediate shaft 4 to pass.

An axial rim 12 also extends from bottom 11 of receptacle 9 toward the front, and forms a cylindrical bore receiving a bearing 13. Bottom 11 of receptacle 9 limits at the engine end the cylindrical bore receiving bearing 13, and defines a rear radial abutment surface of bearing 13. Bearing 13 furthermore interacts with intermediate shaft 4 thanks to a shoulder that defines a front abutment surface of bearing 4. Bearing 13 thus allows centering of intermediate shaft 4 with respect to support element 7.

Bearing 13 has an outer ring, an inner ring, and rolling elements extending between said outer and inner rings. The outer ring is coupled axially to support element 7, while the inner ring is coupled axially to intermediate shaft 4. Bearing 13 is thus axially fastened on the one hand with respect to support element 7 and on the other hand with respect to intermediate shaft 4. This mounting of bearing 13 also allows intermediate shaft 4 to be retained axially with respect to support element 7. For axial coupling of the inner and outer rings, the latter can be force-fitted or adhesively bonded. Alternatively, it is also possible to use one or more locking members such as spring rings or elastic circlips. In the embodiment depicted, inner ring is coupled axially to intermediate shaft 4 via an elastic circlip 14.

Rotor 3 is supported by a hub 15. Hub 15 has an axial skirt supporting rotor 3. Rotor 3 has a package of metal sheets that is mounted by shrink-fitting onto the outer surface of the axial skirt. The package of metal sheets is thus mounted while hot, by shrink-fitting onto the outer surface of the axial skirt.

Support hub 15 of rotor 3 is guided and rotationally centered on support element 7 by means of a bearing 16. For this, axial rim 12 that extends from bottom 11 of receptacle 9 has a cylindrical outer surface supporting the inner ring of bearing 16. The outer ring of bearing 16 furthermore interacts with a cylindrical surface that is configured on the inner surface of hub 15 of rotor 3 and is limited toward the front by a shoulder formed in the inner surface of support hub 15 of rotor 3.

Rotor 3 is furthermore rotationally coupled to intermediate shaft 4 via a mechanical reducer 17 that is illustrated in detail in FIG. 2 and schematically in FIG. 3, and that is received radially inside rotor 3. Mechanical reducer 17 is made up of an epicyclic gear train. The epicyclic gear train has a first outer ring gear 18 carried by support hub 15 of rotor 3, a second outer ring gear 19 fastened to intermediate shaft 4, and satellite gears 20 having double tooth sets mounted rotationally movably on support element 7. Satellite gears 20 have a first tooth set 21 that meshes with first ring gear 18 carried by support hub 15 of rotor 3, and a second tooth set 22 that meshes with second ring gear 19 fastened to intermediate shaft 4. First tooth set 21 has a diameter greater than second tooth set 22, so that the rotation speed of rotor 3 is higher than the rotation speed of intermediate shaft 4. It was found that a reduction ratio of between 0.3 and 0.95 was particularly appropriate for optimizing the performance of pendulum damper 27 and of electric machine 1.

Satellite gears 20 are each carried by means of a peg 23, depicted in particular in FIG. 1, that has a first end inserted inside a central bore of satellite gear 20, and a second end inserted inside a bore configured in support element 3. In the embodiment depicted, the bore that receives peg 23 is configured in axial rim 12 that extends from bottom 11 of receptacle 9, and interacts on the one hand with bearing 13 that provides centering of intermediate shaft 4 with respect to support element 7, and on the other hand with bearing 16 that provides centering of support hub 15 of rotor 3 on element 7.

First ring gear 18 can be shaped directly in support hub 15 of rotor 3, or can be constituted by an added-on gear that is fastened on hub 15.

Second ring gear 19 has an axially oriented skirt inside which are configured its tooth set and a radially oriented annular portion 24. The front end of intermediate shaft 4 has a collar 25 having a shoulder against which annular portion 24 abuts. Fastening members 26, such as bolts, allow annular portion 24 to be fastened to collar 25 of intermediate shaft 4. Second ring gear 19 is thus centered with respect to support element 7 by means of bearing 13, and consequently with respect to support hub 15 of rotor 3 by means of bearing 63.

Note that in the embodiment depicted, the epicyclic gear train is a type III train, i.e. having satellite gears 20 with double tooth sets, and two planets: first and second ring gears 18, 19. Although a type III train of this kind is particularly advantageous in that it offers a limited size and satisfactory force balance, other types of epicyclic gear trains are likewise conceivable.

In the embodiment depicted, the tooth sets of satellite gears 20 are spur tooth sets. Spur teeth of this kind allow a perfectly balanced epicyclic gear train to be achieved, so that bearing 16 that rotationally guides support hub 15 of rotor 3 is optional. In another embodiment the tooth sets of satellite gears 20 are helical gear sets, i.e. tooth sets in which what generates the shape of the teeth is a helical line around the rotation axis of satellite gears 20. Helical teeth of this kind have the advantage of being quieter than spur teeth, creating less vibration. Conversely, however, helical teeth produce axial forces. In such an embodiment it is thus advisable to use load absorbing stops capable of absorbing the axial forces exerted on support hub 15 of rotor 3 and on intermediate shaft 4.

In another embodiment it is also possible to use an epicyclic train of bevel gears, the rotation axis of satellite gears 20 then not being parallel to the rotation axis X.

The transmission assembly furthermore has a pendulum damper 27 and an elastic-member torsional damper 5.

Pendulum damper 27 has a support member and a plurality of pendulum flyweights 28 distributed circumferentially on the support member. Pendulum flyweights 28 are capable of oscillating with respect to the support member in a plane orthogonal to the rotation axis X in reaction to rotational inconsistencies. The support member is rotationally integral with rotor 3. In other words, the rotation speed of the support member is identical to that of rotor 3.

In the embodiments of FIGS. 1, 4, and 5 the support member has two annular flanges 29, 30 extending axially on either side of pendulum flyweights 28. As depicted in FIGS. 4 and 5, one of annular flanges 30 is fastened at a radial rim of support hub 15 of rotor 3. The two annular flanges 29, 30 are furthermore fastened to one another by means of fastening members 31 such as rivets.

The oscillations of pendulum flyweights 28 are guided by guidance means having two cylindrical guidance rollers 32, 33 for each pendulum flyweight 28. The ends of guidance rollers 32, 33 interact with first guidance raceways constituted by the outer edge of openings configured in annular flanges 29, 30 of the support member. Guidance rollers 32, 33 furthermore pass through openings configured in pendulum flyweights 28. The lower edges of the openings configured in pendulum flyweights 28 carry second guidance raceways. The first and second raceways have a generally epicyclic shape and are configured so that the oscillation frequency of pendulum flyweights 28 is proportional to the rotation speed of the combustion engine crankshaft. For more information regarding the structure of pendulum flyweights 28 and of guidance rollers 32, 33, reference may be made to the documents FR 2912504, FR 2989753, FR 2986591, or FR 2986593, which describe in detail pendulum damper structures in which the flyweights extend between two annular flanges.

Note also that in an alternative embodiment (not depicted) the support member has only a single annular flange, and each pendulum flyweight has two sidewalls that extend axially on either side of said annular flange and are connected axially to one another by means of two connecting spacers. Pendulum damper structures of this kind are described in particular in the documents FR 2976641 and FR 2981715.

In the embodiment depicted in FIG. 1, pendulum damper 27 extends at least partly in the plane of interconnector 6, radially inside the latter. The presence of pendulum damper 27 thus has little or no impact on the axial dimension of the transmission assembly.

In the embodiment depicted in FIG. 2, pendulum damper 27 extends radially above elastic-member torsional damper 5. A placement of this kind likewise allows the impact of the pendulum damper on the size of the transmission assembly to be limited. Moreover, this placement also allows an increase in the effectiveness of pendulum damper 27 by shifting the center of gravity of pendulum flyweights 28 radially outward.

In the embodiment illustrated in FIG. 5, the pendulum damper is arranged with respect to rotor 3 on the combustion engine side. The pendulum damper thus extends between inner web 8 of support element 7 and rotor 3. Note also that, as in the embodiment of FIG. 1, pendulum damper 27 extends at least partly in the plane of interconnector 6, radially inside the latter.

In the embodiments depicted in FIGS. 6 and 7, pendulum damper 27 is integrated into the structure of rotor 3. Only a portion of rotor 3 is therefore depicted, in order to make pendulum damper 27 visible. Some of the metal sheets of the metal-sheet package of rotor 3 are cut out in order to configure receiving spaces for pendulum flyweights 28. The support member of pendulum flyweights 28 is then constituted by annular flanges that are arranged axially on either side of the spaces receiving flyweights 28 and are equipped with orifices into which the ends of guidance rollers 32, 33 are inserted. The annular flanges can be constituted by metal sheets of the metal-sheet package, or alternatively can be constituted by specific elements inserted axially between the metal sheets of the metal-sheet package and fastened onto support hub 15 of rotor 3 or onto metal sheets of the metal-sheet package by welding, by bolting, by riveting, or by clinching.

In an embodiment, the support member and/or pendulum flyweights 28 are made of a nonmagnetic material such as a polymer or aluminum, in order to not to disrupt the operation of the electric machine.

Elastic-member torsional damper 5 has an input member rotationally integral with rotor 3, and an output element configured to be rotationally coupled to input shaft 34 of the gearbox. The input element has a front guide washer 35 and a rear guide washer 36. The output element has a web 37 and a splined means 38, fastened to web 37 by means of rivets 39 and intended to interact with splines of complementary shape carried by the rear end of input shaft 34 of the gearbox.

Front guide washer 35 and rear guide washer 36 are arranged axially on either side of web 37. Rear guide washer 36 is fastened to support hub 15 of rotor 3 by means of fastening members 36 such as bolts or rivets. In the embodiment depicted, rear guide washer 36 and second ring gear 19 are fastened to collar 25 of intermediate shaft 4 by common fastening means 26.

The two guide washers, front 35 and rear 36, are rotationally integrated, here by means of axial pins 43 carried by front guide washer 35.

Elastic-member torsional damper 5 has a plurality of groups of two elastic members 44 providing coupling between the two guide washers 35, 36 and web 37. Elastic members 44 here are straight elastic members distributed circumferentially over the same diameter around the axis X. Each elastic member 44 can have two coaxial springs mounted inside one another.

Elastic members 44 are received in windows configured in guide washers 35, 36. Each group of elastic members 44 furthermore extends on the one hand between two abutment seats 40 carried by guide washers 35, 36 and on the other hand between two circumferentially consecutive abutment tabs 41 of web 37.

As depicted in FIG. 6, abutment seats 40 carried by guide washers 35, 36 are added-on parts in the shape of an angular sector, which are fastened onto guide washers 35, 36 on either side of web 37 by means of rivets.

Elastic members 44 of each group are mounted in series by means of a phasing member 42. Phasing member 42 is mounted to rotate freely with respect to guide washers 35, 36 on the one hand and with respect to web 37 on the other hand. Phasing member 42 has radial phasing tabs (not depicted) that are each intercalated between the two consecutive elastic members 44 of a single group, so that the two consecutive elastic members 44 of a single group are arranged in series. The radial phasing tabs have two substantially flat abutment faces forming an angle between them and serving for abutment of the ends of elastic members 44. Phasing member 42 ensures a deformation of elastic members 37 in phase with one another, so that the elastic forces generated in torsional damper 5 are distributed circumferentially in homogeneous fashion.

During operation, each group thus has a first elastic member 44 abutting at a first end against an abutment seat carried by guide washers 35, 36 and at a second end against a radial phasing tab of phasing member 42, while second elastic member 44 abuts at a first end against said radial phasing tab of phasing member 42 and at a second end against an abutment tab 41 of web 37. A driving torque is thus transmitted from guide washers to the web via the elastic members.

Although the invention has been described in conjunction with several specific embodiments, it is quite apparent that it is in no way limited thereto and that it encompasses all technical equivalents of the means described as well as combinations thereof, if they are within the context of the invention.

In particular, a clutch or a torque converter can be arranged in the transmission system between the output of the elastic-member damper and the input shaft of the gearbox.

Use of the verb “have,” “comprise,” or “include,” and of conjugated forms thereof, does not exclude the presence of elements or steps other than those set forth in a claim. Use of the indefinite article “a” or “an” for an element or step does not, unless otherwise indicated, exclude the presence of a plurality of such elements or steps.

In the claims, any reference character in parentheses cannot be interpreted as a limitation of the claim.

1. A transmission assembly for a motor vehicle, intended to be arranged between a combustion engine having a crankshaft and a gearbox having an input shaft, said assembly comprising:
a support element (7);
an electric machine (1) having a stator (2) carried by the support element (7) and a rotor (3) rotationally movable around an axis X, said rotor (3) having a central opening;
an intermediate shaft (4) passing through the central opening of the rotor (3) and intended on the one hand to be connected kinematically to the crankshaft of the combustion engine and on the other hand to be connected kinematically to the input shaft of the gearbox;
a mechanical reducer (17) configured to rotationally couple the rotor (3) and the intermediate shaft (4) in such a way that the rotation speed of the rotor (3) is higher than the rotation speed of the intermediate shaft (4); and
a pendulum damper (27) having a support member (29, 30) rotationally movable around the axis X, and pendulum flyweights (28) mounted movably on the support member (29, 30), the support member (29, 30) being rotationally integral with the rotor (3).

2. The transmission assembly according to claim 1, in which the mechanical reducer (17) is an epicyclic gear train.

3. The transmission assembly according to claim 2, in which the epicyclic gear train extends radially inside the rotor.

4. The transmission assembly according to claim 1, in which the epicyclic gear train has a first ring gear (18) carried by a support hub (15) of the rotor (3), a second ring gear (19) fastened to the intermediate shaft (4), and satellite gears (20) mounted rotationally movably on the support element (7) and extending inside said first and second ring gears (18, 19), said satellite gears (20) each being provided with a first tooth set (21) meshing with the first ring gear (18) and a second tooth set (22) meshing with the second ring gear (19).

5. The transmission assembly according to claim 4, in which the support element (7) has an inner portion extending inside the central opening of the rotor (3); in which the intermediate shaft (4) is centered and rotationally guided on said inner portion of the support element (7) by means of a first bearing (13); and in which the support hub (15) of the rotor (3) is centered and rotationally guided on said inner portion of the support element (7) by means of a second bearing (16).

6. The transmission assembly according to claim 1, in which the rotor (3) is carried by a support hub (15); and in which the support member (29, 30) of the pendulum damper is fastened on the support hub (15) of the rotor (3).

7. The transmission assembly according to claim 6, in which the stator (2) has coils distributed circumferentially around the axis X and an annularly shaped interconnector (6) to interconnect the coils, said interconnector (6) being offset axially with respect to the coils; and in which the pendulum damper (27) is at least partly received radially inside the interconnector (6).

8. The transmission assembly according to claim 6, having an elastic-member torsional damper (5) configured to transmit a torque and to damp rotational irregularities between the intermediate shaft (4) and the input shaft (34) of the gearbox;
and in which the pendulum damper (27) is at least partly arranged in the plane of the elastic-member torsional damper (5) and extends radially above the elastic-member torsional damper (5).

9. The transmission assembly according to claim 1, in which the pendulum damper (27) is integrated into the body of the rotor (3).

10. The transmission assembly according to claim 9, in which the rotor (3) has a body constituted by an axially stacked metal-sheet package; and in which some of the metal sheets of the metal-sheet package have cutouts defining receiving spaces for the pendulum flyweights (28).

11. The transmission assembly according to claim 10, in which the pendulum flyweights (28) are mounted movably on the support member by means of guidance rollers (32, 33) engaged into orifices of the flyweights; and in which the support member for the flyweights (28) has annular flanges that are arranged axially on either side of the receiving spaces for the pendulum flyweights (28) and are equipped with orifices into which the ends of the guidance rollers (32, 33) are engaged.

12. The transmission assembly according to claim 11, in which the annular flanges are constituted by metal sheets of the metal-sheet package.

13. The transmission assembly according to claim 1, in which the support member (29, 30) and/or the pendulum flyweights (28) are produced from a nonmagnetic material.

14. A motor vehicle equipped with a transmission assembly according to claim 1.

15. The transmission assembly according to claim 2, in which the epicyclic gear train has a first ring gear (18) carried by a support hub (15) of the rotor (3), a second ring gear (19) fastened to the intermediate shaft (4), and satellite gears (20) mounted rotationally movably on the support element (7) and extending inside said first and second ring gears (18, 19), said satellite gears (20) each being provided with a first tooth set (21) meshing with the first ring gear (19) and a second tooth set (22) meshing with the second ring gear (20).

16. The transmission assembly according to claim 2, in which the rotor (3) is carried by a support hub (15); and in which the support member (29, 30) of the pendulum damper is fastened on the support hub (15) of the rotor (3).

17. The transmission assembly according claim 3, in which the rotor (3) is carried by a support hub (15); and in which the support member (29, 30) of the pendulum damper is fastened on the support hub (15) of the rotor (3).

18. The transmission assembly according to claim 4, in which the rotor (3) is carried by a support hub (15); and in which the support member (29, 30) of the pendulum damper is fastened on the support hub (15) of the rotor (3).

19. The transmission assembly according to claim 5, in which the rotor (3) is carried by a support hub (15); and in which the support member (29, 30) of the pendulum damper is fastened on the support hub (15) of the rotor (3).
